(19) United States
(12) Patent Application Publication
(10) Pub. No.: US 2013/0155332 A1
(43) Pub. Date: Jun. 20, 2013

(54) METHOD FOR CONTROLLING POWER ON/OFF OF A MULTIMEDIA PLAYER, AND ASSOCIATED APPARATUS

(71) Applicant: Chao-Feng Wei, Hefei City (CN)

(72) Inventor: Chao-Feng Wei, Hefei City (CN)

(21) Appl. No.: 13/610,848

(22) Filed: Sep. 11, 2012

(30) Foreign Application Priority Data
Dec. 15, 2011 (CN) 201110419497.7

(51) Int. Cl. H04N 5/63

(52) U.S. Cl. CPC H04N 5/63
USPC 348/730

(57) ABSTRACT

A method for controlling power on/off of a multimedia player includes: detecting whether at least one user enters at least one predetermined region near the multimedia player; and when it is detected that the user enters the predetermined region, triggering the multimedia player to turn on a main power of the multimedia player, allowing the user to view at least one program provided through the multimedia player. An associated apparatus for controlling power on/off of the multimedia player is also provided. For example, the apparatus may include a portion of the multimedia player, such as a control circuit of the multimedia player. In another example, the apparatus may include the whole of the multimedia player. In particular, the multimedia player can be one or a combination of an optical disc player, a set top box (STB), a television (TV), and/or a TV receiver.

### BACKGROUND

The present invention relates to power control of an audio/video reproducing system, and more particularly, to a method for controlling power on/off of a multimedia player, and to an associated apparatus.

Planar display devices such as liquid crystal display (LCD) panels are widely used in various kinds of application fields. For example, some LCD televisions (TVs)/monitors are utilized for advertisement purposes in outlets, hotels, etc., and more particularly, are installed on the wall of an elevator or on the wall near the elevator entrance, so that those who are in front of these LCD TVs/monitors may watch the advertisements. Typically, these LCD TVs/monitors are continuously turned on, wasting electric power without achieving anything in a situation where nobody is in front of them. Thus, as there is now a sense of urgency in saving the planet, a novel method is required for preventing unnecessary power consumption of these LCD TVs/monitors.

### SUMMARY

It is therefore an objective of the claimed invention to provide a method for controlling power on/off of a multimedia player, and to provide an associated apparatus, in order to save power. As a result of applying the method, unnecessary power consumption can be prevented.

An exemplary embodiment of a method for controlling power on/off of a multimedia player comprises: detecting whether at least one user enters at least one predetermined region near the multimedia player; and when it is detected that the user enters the predetermined region, triggering the multimedia player to turn on a main power of the multimedia player, allowing the user to view at least one program provided through the multimedia player. In particular, according to some embodiments, the method further comprises: when it is detected that the user enters the predetermined region, detecting whether the user enters the predetermined region multiple times; and when it is detected that the user enters the predetermined region multiple times, triggering the multimedia player to play a second portion of the program, allowing the user to view the second portion of the program, wherein a first portion of the program is played when the user enters the predetermined region at a previous time, and a second start time index of the second portion is different from a first start time index of the first portion.

An exemplary embodiment of an associated apparatus for controlling power on/off of a multimedia player comprises a control circuit arranged to control operations of the multimedia player, wherein the processing circuit comprises a detection module and a processing module. The detection module is arranged to detect whether at least one user enters at least one predetermined region near the multimedia player. In addition, when it is detected that the user enters the predetermined region, the processing module triggers the multimedia player to turn on a main power of the multimedia player, allowing the user to view at least one program provided through the multimedia player. For example, the apparatus may comprise at least one portion (e.g. a portion or all) of the multimedia player. In particular, the multimedia player can be one or a combination of an optical disc player, a set top box (STB), a television (TV), and/or a TV receiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of an apparatus for controlling power on/off of a multimedia player according to a first embodiment of the present invention.

FIGS. 1B-1C respectively illustrate some implementation details involved with the apparatus shown in FIG. 1A according to different embodiments of the present invention.

FIG. 2A is a flowchart of a method for controlling power on/off of a multimedia player according to an embodiment of the present invention.

FIG. 2B illustrates a working flow involved with the method shown in FIG. 2A according to an embodiment of the present invention.

FIG. 2C illustrates a working flow involved with the method shown in FIG. 2A according to another embodiment of the present invention.

FIGS. 3A-3C respectively illustrate some implementation details involved with the method shown in FIG. 2A according to an embodiment of the present invention.

FIG. 4 is a diagram of an apparatus for controlling power on/off of a multimedia player according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

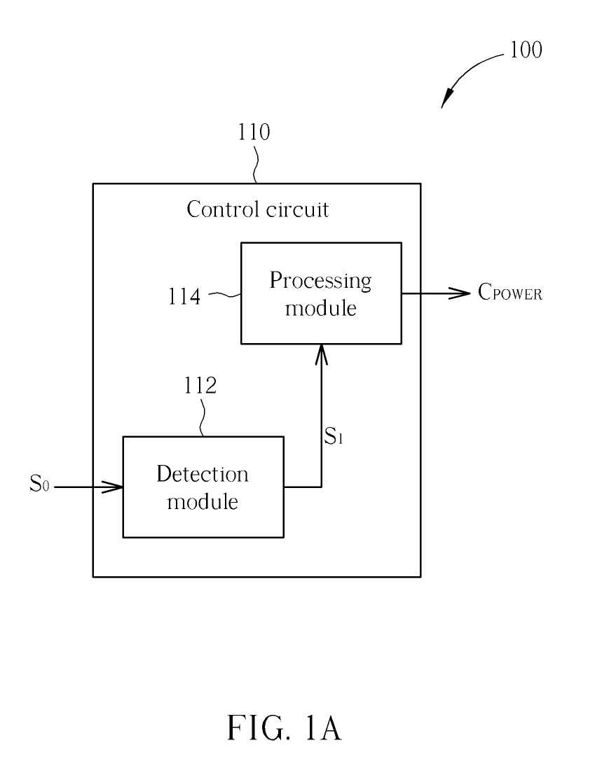

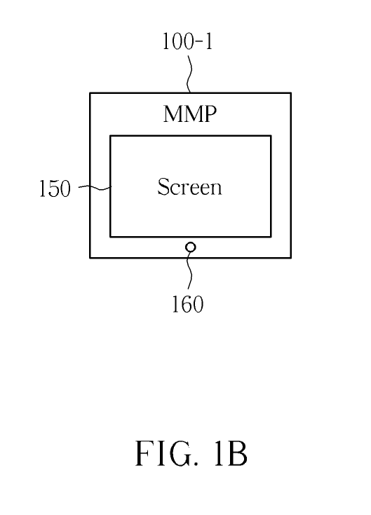

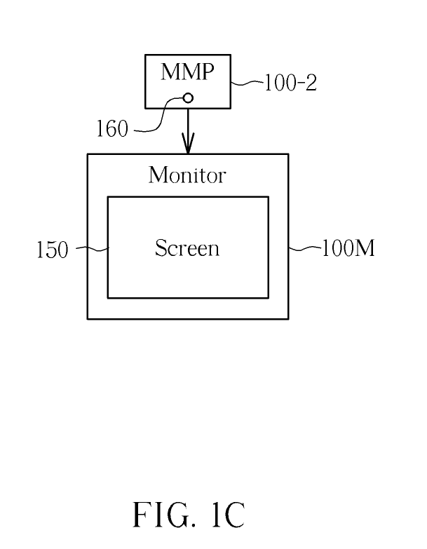

Please refer to FIG. 1A, which illustrates a diagram of an apparatus 100 for controlling power on/off of a multimedia player according to a first embodiment of the present invention. The apparatus 100 comprises a control circuit 110 arranged to control operations of the multimedia player, where the processing circuit 110 comprises a detection module 112 and a processing module 114. The detection module 112 is arranged to detect whether at least one user enters at least one predetermined region near the multimedia player according to an input signal S₀, and output a detection result signal S₁ indicating the detection result of the detection performed by the detection module 112. In addition, when it is detected that the user enters the predetermined region, the processing module 114 triggers the multimedia player to turn on a main power of the multimedia player through a power control signal C_{POWER}, allowing the user to view at least one program provided through the multimedia player. For example, the apparatus 100 may comprise at least one portion (e.g. a portion or all) of the multimedia player. In a situation where the apparatus 100 comprises a portion of the multimedia player, the control circuit 110 can be the control circuit of the multimedia player, such as an integrated circuit (IC). In a situation where the apparatus 100 comprises the whole of the multimedia player, the apparatus 100 can be the multimedia player, or can be an audio/video reproducing system comprising the multimedia player.

In particular, the multimedia player mentioned above can be one of an optical disc player (e.g. a digital versatile disc (DVD) player, or a Blu-ray disc (BD) player), a set top box (STB), a television (TV), and a TV receiver, or can be a combination of an optical disc player (e.g. a DVD player, or a BD player), an STB, a TV, and/or a TV receiver. Some exemplary embodiments thereof are illustrated in FIGS. 1B-1C. Referring to FIG. 1B, the multimedia player 100-1 (labeled “MMP”) comprises a screen 150 (e.g. an LCD panel) for displaying images of the program, and further comprises a detection device 160 (e.g. an optical detection device) arranged to perform optical detection in order to generate the input signal S₀ mentioned above, where the apparatus 100 may comprise at least one portion (e.g. a portion or all) of the multimedia player 100-1. Referring to FIG. 1C, the multimedia player 100-2 (labeled “MMP”) comprises the detection device 160 arranged to perform optical detection in order to generate the input signal S₀ mentioned above, and is capable of controlling the power on/off status of the monitor 100M comprising the screen 150 (e.g. an LCD panel), which is utilized for displaying images of the program, and more particularly, the images carried by at least one signal sent from the multimedia player 100-2, where the apparatus 100 may comprise at least one portion (e.g. a portion or all) of the multimedia player 100-2.

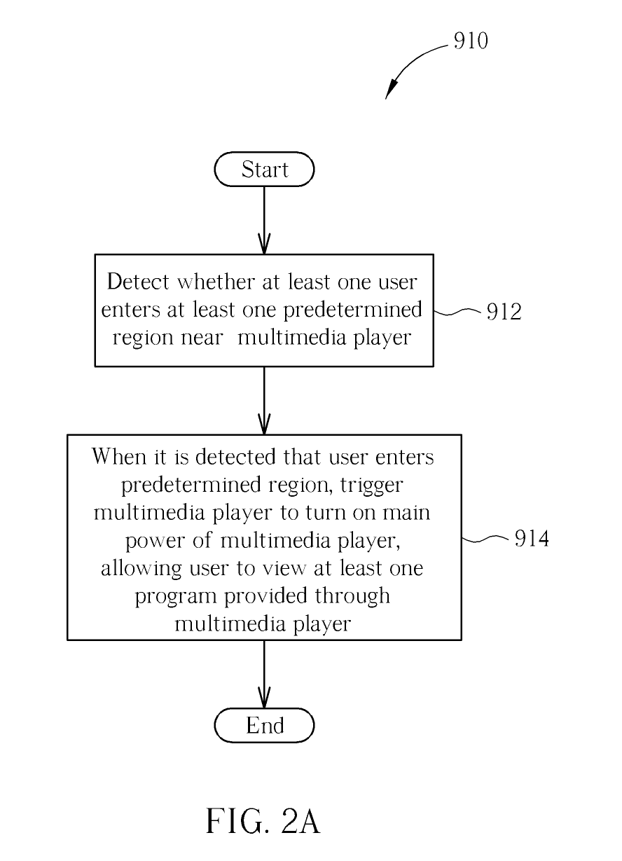

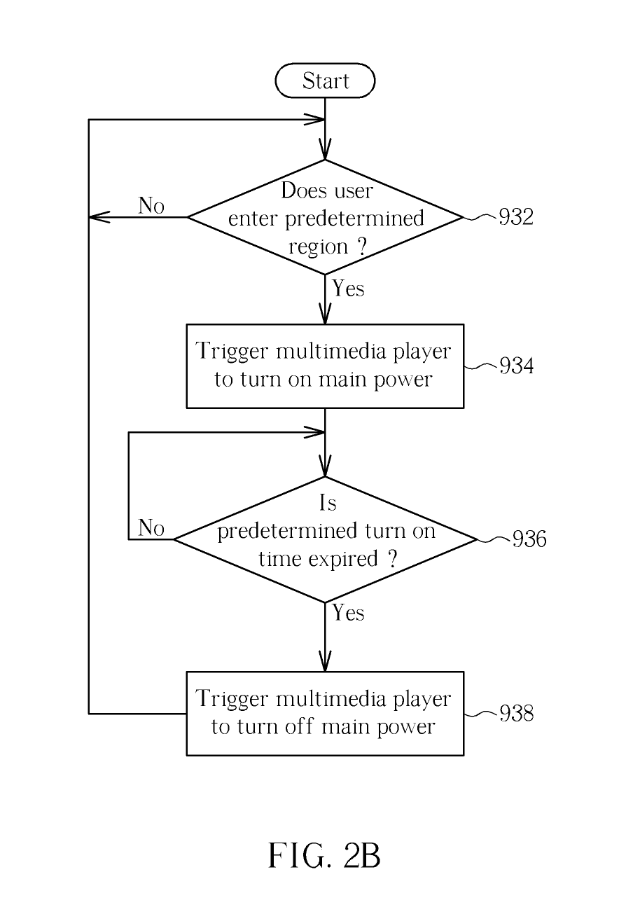

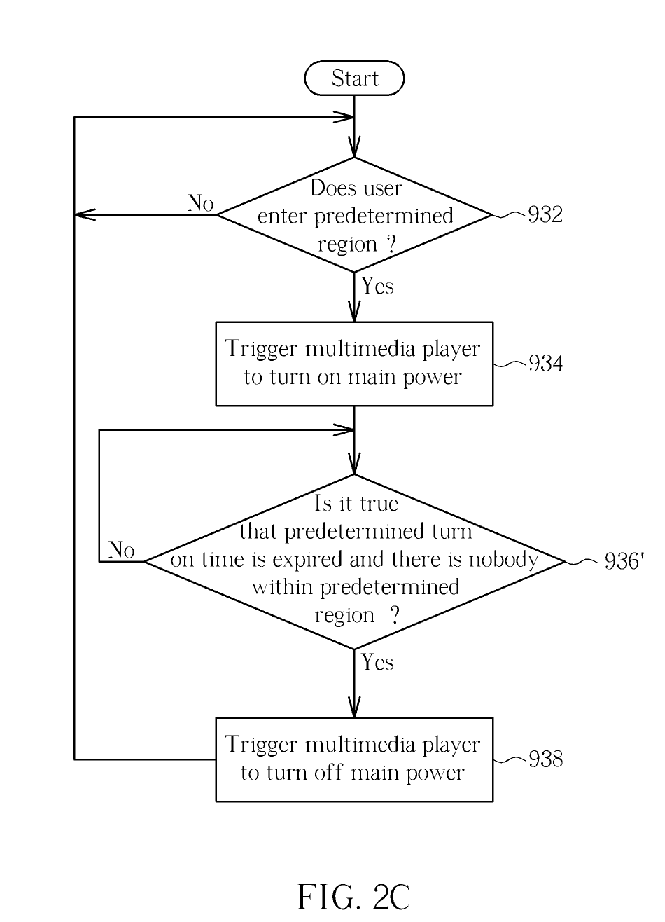

FIG. 2A is a flowchart of a method 910 for controlling power on/off of a multimedia player according to an embodiment of the present invention. The method 910 shown in FIG. 2A can be applied to the apparatus 100 shown in FIG. 1A. The method is described as follows.

In Step 912, the detection module 112 detects whether at least one user (e.g. one or more users) enters at least one predetermined region (e.g. one or more predetermined regions) near the multimedia player. In practice, the detection module 112 can detect whether the user enters the predetermined region by utilizing optical detection, and more particularly, by utilizing at least one optical detection device. For example, the aforementioned at least one optical detection device may comprise at least one photo resistor, at least one infrared (IR) detection device, and/or at least one camera, which means the detection module 112 can detect whether the user enters the predetermined region by utilizing the aforementioned at least one photo resistor, the aforementioned at least one IR detection device, and/or the aforementioned at least one camera.

In Step 914, when it is detected that the user enters the predetermined region, the processing module 114 triggers the multimedia player to turn on the main power of the multimedia player, allowing the user to view at least one program (e.g. one or more programs) provided through the multimedia player. More particularly, when it is detected that the user enters the predetermined region, the processing module 114 can trigger the multimedia player to turn on the main power, in order to actively play the program in response to the appearance of the user. Please note that the user has no need to press any button or any virtual button (e.g. a virtual button implemented with a touch screen), and therefore, it is unnecessary to install such a button/virtual button for those who are supposed to watch the program. For example, the program can be an advertisement. In another example, the program can be an educational program.

According to this embodiment, as the apparatus 100 can automatically turn on the main power in response to the appearance of the user, the multimedia player can be arranged to stay in a standby status by default. As a result of applying the method, the apparatus 100 can save power by preventing unnecessary power consumption. For example, referring to FIG. 1B, unnecessary power consumption of the multimedia player 100-1 can be prevented. In another example, referring to FIG. 1C, unnecessary power consumption of both the multimedia player 100-2 and the monitor 100M can be prevented.

According to a variation of this embodiment, when it is detected that the user enters the predetermined region, the processing module 114 can detect whether the user enters the predetermined region multiple times. More particularly, when it is detected that the user enters the predetermined region multiple times, the processing module 114 can trigger the multimedia player to play a second portion of the program, allowing the user to view the second portion of the program, where a first portion of the program is played when the user enters the predetermined region at a previous time, and a second start time index of the second portion is different from a first start time index of the first portion. In practice, the processing module 114 can detect whether the user enters the predetermined region multiple times by detecting at least one portion of a face of the user (e.g. by eye detection or by face detection). This is for illustrative purposes only, and is not meant to be a limitation of the present invention. According to some other variations of this embodiment, detecting whether the user enters the predetermined region multiple times is not required. In these variations, as there are lots of video clips (or video contents) within the program mentioned above, the present invention can prevent the user from repeatedly watching the same portion(s) of the program.

According to another variation of this embodiment, when it is detected that the user enters the predetermined region, the processing module 114 can classify the user into a specific type of a plurality of predetermined types, and trigger the multimedia player to play a specific portion of the program, allowing the user to view the specific portion of the program, where a plurality of portions of the program such as the video clips respectively correspond to the plurality of predetermined types, and the specific portion corresponds to the specific type. In practice, the plurality of predetermined types may comprise an elder type representing elders, a child type representing children, a man type representing men, and/or a woman type representing women.

According to another variation of this embodiment, in a situation where the aforementioned at least one user comprises a plurality of users, the detection module 112 can detect whether the plurality of users enters the predetermined region by utilizing the aforementioned at least one camera. More particularly, when it is detected that the plurality of users enters the predetermined region, the detection module 112 can classify any of the users into one of the plurality of predetermined types mentioned above, and trigger the multimedia player to play a specific portion of the program, allowing the users to view the specific portion of the program. Please note that the plurality of portions of the program such as the video clips still respectively correspond to the plurality of predetermined types mentioned above in this variation. However, the specific portion corresponds to a specific type having the maximum number of persons within the users. In practice, the plurality of predetermined types may comprise the aforementioned elder type representing elders, the aforementioned child type representing children, the aforementioned man type representing men, and/or the aforementioned woman type representing women.

FIG. 2B illustrates a working flow involved with the method 910 shown in FIG. 2A according to an embodiment of the present invention.

In Step 932, the detection module 112 checks whether the user (e.g. the one or more users mentioned in Step 912) enters the predetermined region (e.g. the one or more predetermined regions mentioned in Step 912). When it is detected that the user enters the predetermined region, Step 934 is entered; otherwise, Step 932 is re-entered.

In Step 934, the processing module 114 triggers the multimedia player to turn on the main power.

In Step 936, the processing module 114 checks whether a predetermined turn on time (e.g. multiple seconds, or one or more minutes) is expired. For example, the predetermined turn on time can be a constant that is determined in advance. In another example, the predetermined turn on time can temporarily be a fixed value that is determined in advance, and can be adjustable. When it is detected that the predetermined turn on time is expired, Step 938 is entered; otherwise, Step 936 is re-entered.

In Step 938, the processing module 114 triggers the multimedia player to turn off the main power. After Step 938 is executed, Step 932 is re-entered.

Thus, according to this embodiment or some variations thereof, after triggering the multimedia player (e.g. the multimedia player mentioned in Step 912) to turn on the main power, the processing module 114 can trigger the multimedia player to turn off the main power when it is detected that the predetermined turn on time is expired.

According to some variations of this embodiment, in a situation where the predetermined turn on time is adjustable, the processing module 114 can adaptively adjust the predetermined turn on time in response to at least one user activity. For example, when it is detected that the user keeps staying within the predetermined region mentioned above (e.g. the one or more predetermined regions mentioned in Step 912), the processing module 114 can adaptively increase the predetermined turn on time. In another example, when it is detected that an average of appearance time intervals of a plurality of users is much less than the predetermined turn on time, the processing module 114 can adaptively decrease the predetermined turn on time. This is for illustrative purposes only, and is not meant to be a limitation of the present invention. According to some other variations of this embodiment, whether the predetermined turn on time is expired is not the only criterion for determining whether to turn off the main power. In these variations, the processing module 114 can further check whether there is nobody within the predetermined region mentioned above (e.g. the one or more predetermined regions mentioned in Step 912), in order to determine whether to turn off the main power. For example, in one of these variations, such as the embodiment shown in FIG. 2C, Step 936 mentioned in the embodiment shown in FIG. 2B can be replaced by Step 936′ as follows:

In Step 936′, the processing module 114 checks whether a predetermined turn on time (e.g. multiple seconds, or one or more minutes) is expired and whether there is nobody within the predetermined region. When it is detected that the predetermined turn on time is expired and that there is nobody within the predetermined region, Step 938 is entered; otherwise, Step 936 is re-entered.

Thus, in these variations, after triggering the multimedia player (e.g. the multimedia player mentioned in Step 912) to turn on the main power, the processing module 114 can trigger the multimedia player to turn off the main power when it is detected that the predetermined turn on time is expired and that there is nobody within the predetermined region. In particular, according to some of these variations, the predetermined turn on time can be adjustable, and the processing module 114 can adaptively adjust the predetermined turn on time in response to at least one user activity.

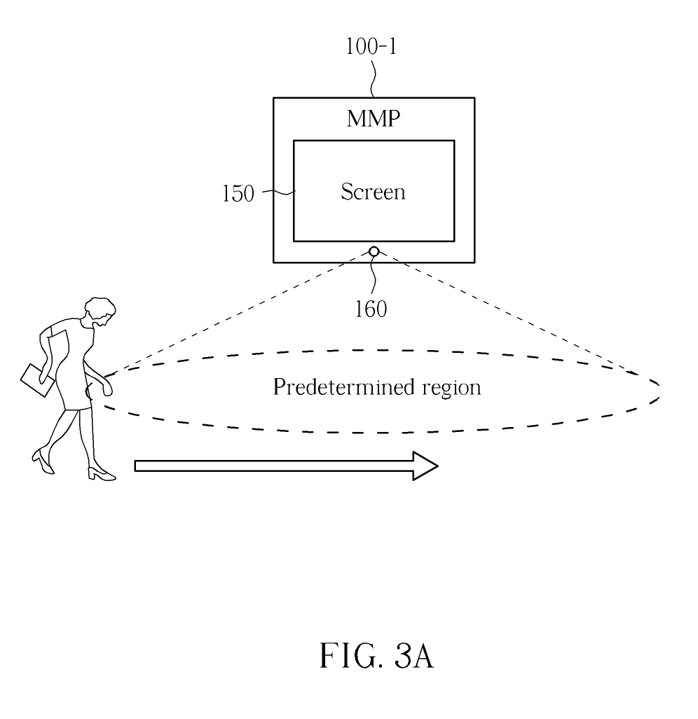

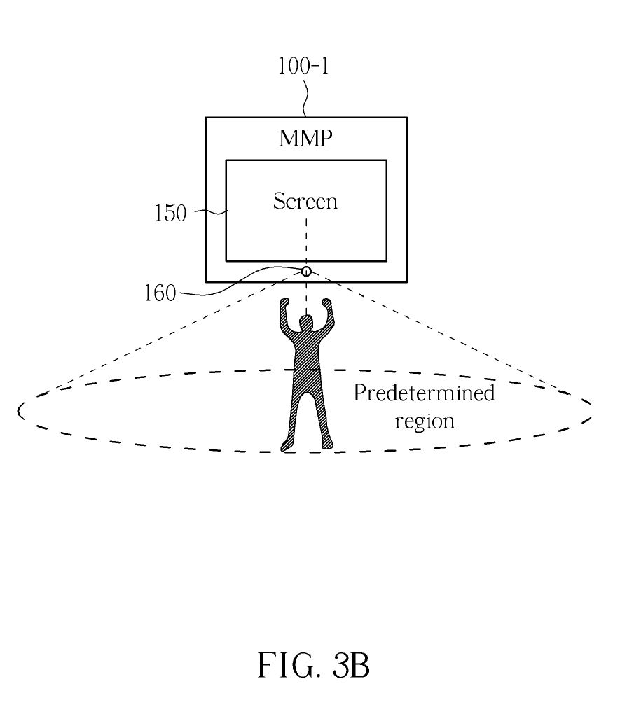

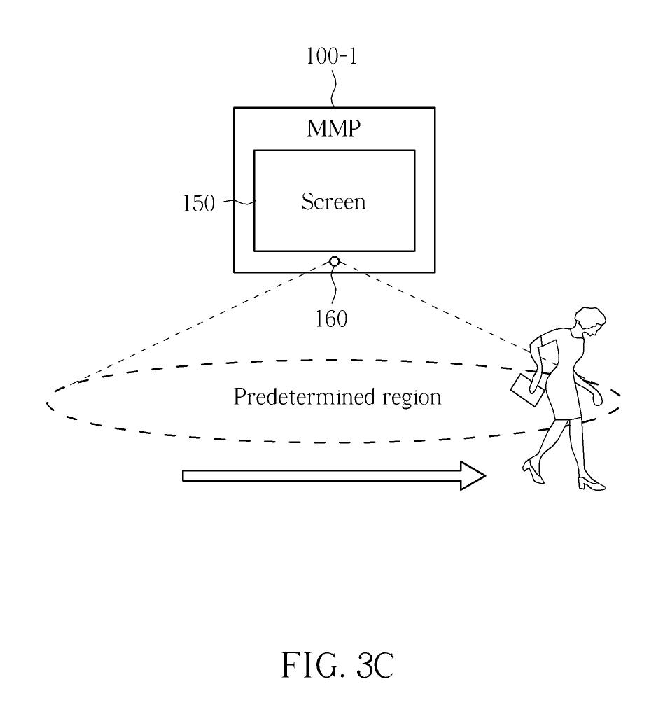

FIGS. 3A-3C respectively illustrate some implementation details involved with the method 910 shown in FIG. 2A according to an embodiment of the present invention. For better comprehension, the multimedia player 100-1 (labeled “MMP”) shown in FIG. 1B can be taken as an example of the multimedia player mentioned in Step 912. This is for illustrative purposes only, and is not meant to be a limitation of the present invention. According to some variations of this embodiment, the multimedia player 100-2 (labeled “MMP”) shown in FIG. 1C can be taken as an example of the multimedia player mentioned in Step 912.

Referring to FIG. 3A, when it is detected that the user enters the predetermined region, which is in front of the multimedia player 100-1 in this embodiment, the processing module 114 triggers the multimedia player 100-1 to turn on the main power of the multimedia player 100-1, allowing the user to view the program mentioned in Step 914. Referring to FIG. 3B, as the main power of the multimedia player 100-1 is turned on, the user stays for a while within the predetermined region and watches the program. Referring to FIG. 3C, the user leaves for another place, such as an original destination of the user or a new destination proposed by the program. For example, in a situation where the program comprises information regarding the original destination and/or the new destination (e.g. traffic information such as a traffic report), the user may determine the new destination, or determine a new path for the original destination. Thus, the present invention can be helpful on traffic improvement.

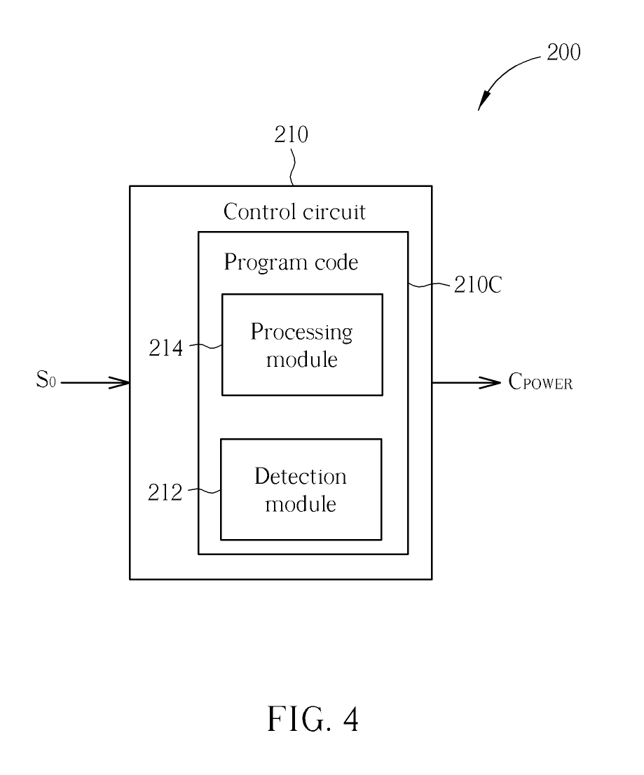

FIG. 4 is a diagram of an apparatus 200 for controlling power on/off of a multimedia player according to a second embodiment of the present invention. According to this embodiment, the control circuit mentioned above can be implemented by utilizing a processing circuit executing a program code 210C, and therefore, can be labeled with another numeral 210 in response to the change in architecture, where the apparatus mentioned above can be labeled with the numeral 200 in response to the change in architecture. In addition, the program code 210C may comprise at least one program module, such as a detection module 212 and a processing module 214, where the control circuit 210 executing the detection module 212 can perform operations that are the same as or similar to those of the detection module 112, and the control circuit 210 executing the processing module 214 can perform operations that are the same as or similar to those of the processing module 114. Similar descriptions are not repeated for this embodiment.

It is an advantage of the present invention that the present invention method and apparatus can save power by preventing unnecessary power consumption. In addition, according to some embodiments, the present invention method and apparatus can be helpful on traffic improvement.

Those skilled in the art will readily observe that numerous modifications and alterations of the device and method may be made while retaining the teachings of the invention.

What is claimed is:

1. A method for controlling power on/off of a multimedia player, the method comprising:
detecting whether at least one user enters at least one predetermined region near the multimedia player; and
when it is detected that the user enters the predetermined region, triggering the multimedia player to turn on a main power of the multimedia player, allowing the user to view at least one program provided through the multimedia player.

2. The method of claim 1, wherein the step of detecting whether the at least one user enters the at least one predetermined region near the multimedia player further comprises:
detecting whether the user enters the predetermined region by utilizing optical detection.

3. The method of claim 2, wherein the step of detecting whether the at least one user enters the at least one predetermined region near the multimedia player further comprises:
detecting whether the user enters the predetermined region by utilizing at least one photo resistor.

4. The method of claim 2, wherein the step of detecting whether the at least one user enters the at least one predetermined region near the multimedia player further comprises:
detecting whether the user enters the predetermined region by utilizing at least one infrared (IR) detection device.

5. The method of claim 2, wherein the step of detecting whether the at least one user enters the at least one predetermined region near the multimedia player further comprises:
detecting whether the user enters the predetermined region by utilizing at least one camera.

6. The method of claim 5, wherein the at least one user comprises a plurality of users; and
the step of detecting whether the at least one user enters the at least one predetermined region near the multimedia player further comprises:
detecting whether the plurality of users enters the predetermined region by utilizing the at least one camera.

7. The method of claim 6, further comprising:
when it is detected that the plurality of users enters the predetermined region, classifying any of the users into one of a plurality of predetermined types, and triggering the multimedia player to play a specific portion of the program, allowing the users to view the specific portion of the program, wherein a plurality of portions of the program respectively correspond to the plurality of predetermined types, and the specific portion corresponds to a specific type having a maximum number of persons within the users.

8. The method of claim 1, wherein the step of triggering the multimedia player to turn on the main power of the multimedia player further comprises:
when it is detected that the user enters the predetermined region, triggering the multimedia player to turn on the main power, in order to actively play the program in response to appearance of the user.

9. The method of claim 1, further comprising:
after triggering the multimedia player to turn on the main power, triggering the multimedia player to turn off the main power when it is detected that a predetermined turn on time is expired and that there is nobody within the predetermined region.

10. The method of claim 1, wherein the program is an advertisement.

11. The method of claim 1, further comprising:
when it is detected that the user enters the predetermined region, detecting whether the user enters the predetermined region multiple times; and
when it is detected that the user enters the predetermined region multiple times, triggering the multimedia player to play a second portion of the program, allowing the user to view the second portion of the program, wherein a first portion of the program is played when the user enters the predetermined region at a previous time, and a second start time index of the second portion is different from a first start time index of the first portion.

12. The method of claim 11, wherein the step of detecting whether the user enters the predetermined region multiple times further comprises:
detecting whether the user enters the predetermined region multiple times by detecting at least one portion of a face of the user.

13. The method of claim 1, further comprising:
when it is detected that the user enters the predetermined region, classifying the user into a specific type of a plurality of predetermined types, and triggering the multimedia player to play a specific portion of the program, allowing the user to view the specific portion of the program, wherein a plurality of portions of the program respectively correspond to the plurality of predetermined types, and the specific portion corresponds to the specific type.

14. The method of claim 13, wherein the plurality of predetermined types comprises an elder type representing elders, a child type representing children, a man type representing men, and/or a woman type representing women.

15. An apparatus for controlling power on/off of a multimedia player, the apparatus comprising:
a control circuit arranged to control operations of the multimedia player, wherein the processing circuit comprises:
a detection module arranged to detect whether at least one user enters at least one predetermined region near the multimedia player; and
a processing module, wherein when it is detected that the user enters the predetermined region, the processing module triggers the multimedia player to turn on a main power of the multimedia player, allowing the user to view at least one program provided through the multimedia player.

16. The apparatus of claim 15, wherein the detection module is arranged to detect whether the user enters the predetermined region by utilizing optical detection.

17. The apparatus of claim 15, wherein when it is detected that the user enters the predetermined region, the processing module triggers the multimedia player to turn on the main power, in order to actively play the program in response to appearance of the user.

18. The apparatus of claim 15, wherein after triggering the multimedia player to turn on the main power, the processing module triggers the multimedia player to turn off the main power when it is detected that a predetermined turn on time is expired and that there is nobody within the predetermined region.

19. The apparatus of claim 15, wherein the apparatus comprises at least one portion of the multimedia player.

20. The apparatus of claim 15, wherein the multimedia player is one or a combination of an optical disc player, a set top box (STB), a television (TV), and/or a TV receiver.
